(19) United States
(12) Patent Application Publication
(10) Pub. No.: US 2001/0050477 A1
(43) Pub. Date: Dec. 13, 2001

(54) Multi tiered indicia labeling system

(76) Inventor: Andrew M. Hiller, Fort Collins, CO (US)

Correspondence Address: William E. Hein, Attorney at law, P.O. Box 335, Loveland, CO, 80539-0335, US

(21) Appl. No.: 09/751,092

(22) Filed: Dec. 29, 2000

Related U.S. Application Data
(60) Provisional application No. 60/175,073, filed on Jan. 7, 2000.

(51) Int. Cl. B42D 15/00; G09C 3/00

(52) U.S. Cl. 283/81

(57) ABSTRACT

A multi-tiered indicia system and method of use thereof with a collection of objects, implements or tools serves to identify the members common to the collection with a first tier indicia applied thereto. Additional tiers of indicia applied thereto may simultaneously provide the individual members with corresponding identifiers of their unique attributes, thereby simplifying and promoting accurate identification and selection of a desired individual object, implement or tool from the collection. The multiple tiers may also be used to differentiate multiple collections and families of collections from one another.

### REFERENCE TO RELATED APPLICATION

This application claims the benefit of U.S. Provisional Patent Application Ser. No. 60/175,073 filed Jan. 7, 2000.

### BACKGROUND OF THE INVENTION

Generally, this invention relates to a multi-tiered indicia labeling system used to identify collections of objects and to aid in the selection of individual objects from within each collection of objects. Specifically, the invention relates to a system for labeling groups of tools and for identification of single tools within the group at a glance.

You can never find it when need it. The need to be able to easily identify and select a single desired implement from among an assemblage of similar implements has been long standing. This is especially the case under working conditions in which frequent use of a variety of specifically sized or styled implements must be identified and re-identified, selected and reselected from a collection of similar implements.

It may be a significant problem when work tasks are made more difficult because the correct implement cannot be rapidly selected from a broad variety of implements or tools. This problem is magnified when the task requires repeated use of several implements, requiring repeated proper identification and selection.

Another problem may occur when a particular implement from the group is seldom used. As a result, that implement is less recognizable to the user due to infrequent contact. As a result, making the proper selection requires more time and greater effort, and often results in more selection errors.

Another problem may occur in instances in which the collection of implements is not immediately adjacent to the user needing the correct implement or in which the user is in a physical position that requires extra effort in order to gain access to the required implement. Thus, accurately identifying and selecting the correct implement from among the implement collection the first time is especially important, given the extra effort and time required to reselect an implement that was first incorrectly selected.

Yet another problem may be that many collections of implements contain size and style markings that are not easily discerned. Relative to the implement itself, markings are frequently small, making fast and accurate selection impossible. Oftentimes, several possibly correct implements must be selected, handled, and viewed closely to identify the required implement, with the others then cast aside. This is the case not only with implements within a particular collection, but also between various collections or families of collections.

Still another problem may be that size and style markings may be raised or embossed on individual implements. This often adds to the problem of correct identification and selection after the implement has been in service for some time. Raised markings wear down with time, and embossed markings fill up with soil.

Another problem may occur when a collection of mismatched implements has been assembled from a variety of sources or manufacturers. In this case, the indicia among the collection are not necessarily uniform. Each implement may be marked in a different manner, on a different area of the implement, use a different type font and size or be subject to a varying amount of wear to the marking. As a result, making the proper selection becomes even more problematic.

Another problem may be that there has been no attempt to create a universality or standardization of the manner of the indicia with which the implements may be marked. A collection of implements from one manufacturer may contain indicia that are substantially different from another manufacturer in terms of indicia location, size, method, font, and prominence. The user, therefore, is forced to reacquaint himself with a new indicia system for each different implement collection used.

Another problem may be that indicia are only designed to be read by electronic means or may be confusing when read by the human eye. This occurs, for example, when multiple colors are used to distinguish digits, such as described in U.S. Pat. Nos. 4,856,820 and 4,982,627.

Yet another problem may occur when indicia are designed to be incorporated as a step in the manufacturing process and are not designed for use with already existing implements or are not suitable for use with other types of implements such as box or open end wrenches, as disclosed in U.S. Pat. Nos. 4,947,713, 3,641,319, and 5,197,764.

Still another problem may be labels which have only a single tier of indicia which does not allow for differentiation between different sets of implements as disclosed in U.S. Pat. Nos. 4,947,713, 1,984,839, 4,344,644, 5,031,488, and 5,330,230.

Another problem with existing indicia systems may be the use of multiple labels to indicate numerator and denominator of factional sizes of tools. This may require learning a new system or the understanding of fractional arithmetic. Fractions may also be read backward, depending upon the position of a tool when viewed as disclosed in U.S. Pat. No. 5,031,488.

Still another problem may be that the marking indicia may not be intended to be permanent. Inventory marking systems are often not designed for long term use, as disclosed by U.S. Pat. No. 4,344,644.

Another problem is the unavailability of an aftermarket system for correcting indicia problems for collections of implements available to users already in possession of implements with the inherent problems previously described.

The present invention offers a simple, low cost, easy-to-use solution that addresses each of the above-mentioned problems in identifying collections of objects, implements, or tools, and in selecting the correct object, implement, or tool from such a collection or collections.

### SUMMARY OF THE INVENTION

One of the broad objectives of an embodiment of the present invention is to allow a user to immediately identify the desired collection of objects, implements or tools, and to identify individual objects, implements or tools within the collection at a glance.

Another object of an embodiment of the present invention is to allow the user to identify the desired collection of objects, implements or tools, and to further identify individual objects, implements or tools within the collection, even from a significant distance without actually handling them.

Another object of an embodiment of the present invention may be to create a universality of indicia within a user's collection(s) of implements whereby all implements of a given size, style or function will bear the same color-coded indicia whether they are from the same or a different manufacturer, new or used, same or different sources, and regardless of the original indicia on the implements.

Another object of an embodiment of the present invention is to easily confirm proper implement selection by clearly providing indicia indicative of size, style, collection or family of a collection on a color-coded label that is affixed to the implement.

Another object of an embodiment of the present invention may be to provide increased bond strength between the label and the object being labeled.

Further independent objects of the present invention are disclosed hereinbelow.

### BRIEF DESCRIPTION OF THE DRAWINGS

FIG. 1 shows an embodiment of the present invention using a single color indicia.

FIG. 2 shows an embodiment of the present invention using two-color indicia.

FIG. 3 shows an embodiment of the present invention using three-color indicia.

FIG. 4 shows an embodiment of the present invention incorporating a highlighted numeric or alphabetic indicia.

FIG. 5 shows an embodiment of the invention having hebetative force disseminating termini.

FIG. 6 shows the side of the substrate opposite the side with indicia for a particular embodiment of the invention.

FIG. 7 shows one embodiment of the invention produced with varying lengths and widths on a common peelable sheet.

FIG. 8 shows a collection of tools in which labels having two-tiered color-coded indicia thereon are used to identify the collection.

### DETAILED DESCRIPTION OF THE PREFERRED EMBODIMENTS

The present invention constitutes a multi-tiered indicia system and the methods which disclose how to make and how to use multi-tiered indicia technology. In one embodiment of the invention, a multi-tiered labeling system may be used with a collection of objects, implements or tools to identify the members common to the collection with a first tier indicia. A second tier indica on the label may simultaneously provide the individual members with an identifier of their unique attributes. Multi-tiered labeling simplifies and promotes accurate identification and selection of a desired individual object, implement or tool from the collection, and may also be used to differentiate collections and families of collections from one another. This form of multitiered indicia may be incorporated into various embodiments including, but not limited to, wraps, sleeves, labels, molded plastics, and the like which may be made responsive to an object, implement or tool.

Referring first to FIG. 1, a label (1) embodiment of the invention using a first tier indica (2), such as a single color identifier, may be used to identify an individual implement, such as a tool, within a single set of implements. The substrate (3) of the label (1) may be made from any material sufficiently conformable to take the shape of the object, implement or tool to which it is affixed. Exemplary of such a substrate is sheet stock made from paper, plastic, metal or other conformable material.

As shown in FIG. 2, a second tier indicia (4), such as a series of diagonal hash marks, would indicate a collection designation in addition to the individual designation. For example, FIG. 2 might indicate that the tool is from the metric measurement family as opposed to the SAE measurement family. The second tier may be established as a contrasted uniform pattern over the first indicia for easy identification.

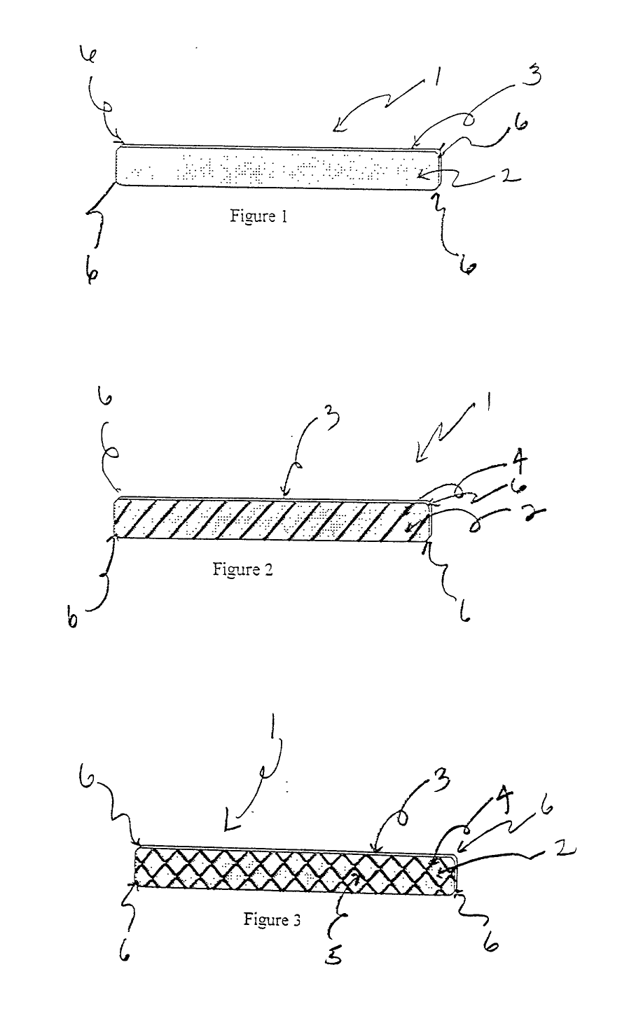

FIG. 3 shows the addition of a third tier indicia (5) to those already existing, thereby adding a third level of information discernable at a glance. In this example, an opposite diagonal hatch has been added that might indicate a third identification tier. For example, the additional diagonal hatch might indicate that the tool is from a particular collection, such as that of an organizational department or individual's collection. Thus, taken together at a glance, the tree tiers of information would indicate the tool is of a certain measurement from the metric family and belonging to the fleet maintenance department, for example. Additional tiers of indica may be added as necessary to designate increasing levels of relationship between the individual objects, implements or tools.

The indica need not be visually observable. In one embodiment of the invention the tiers of indicia may comprise raised surfaces of varying heights and shape. A tier of indica may also comprise discernable odors on the substrate material while the second tier indica may then comprise a raised surface. Naturally combinations and permutations of color, raised surfaces, and the like are achievable.

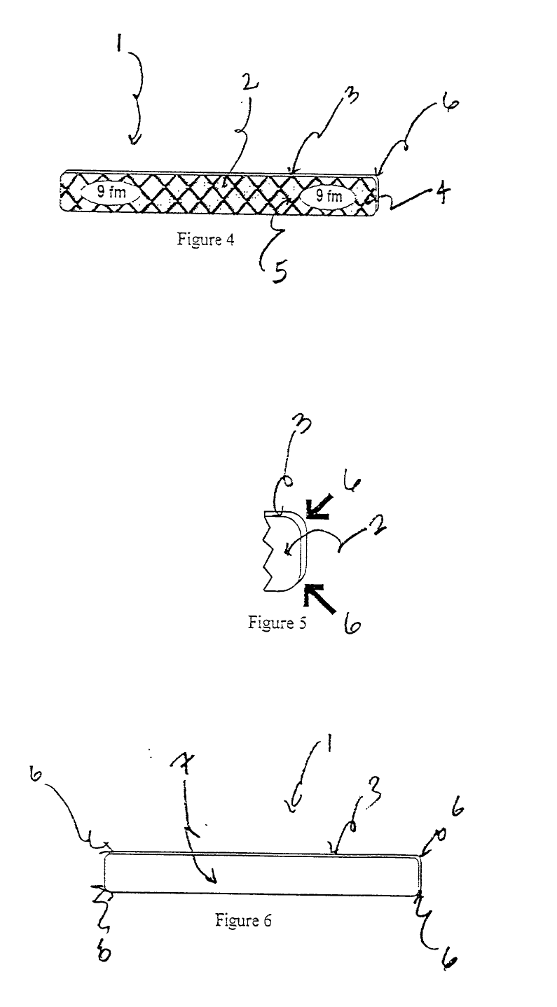

FIG. 4 shows the same surface of the substrate incorporating a highlighted numeric or alphabetic tier of indicia for fast confirmation of the information indicated by the primary tiers of indicia.

With respect to the labeling embodiment of the invention, hebetated force disseminating termini (6), having rounded corners, may be incorporated, as shown in FIG. 5. The first effect of this element may be to make the label substrate less susceptible to separation from the substrate of the object, implement or tool. The second effect of this element may be to make the user less susceptible to injury due to the sharpness of certain types of label materials.

The labeling embodiment of the invention may incorporate an adhesive material (7) impregnating the surface opposite the indica side of the label, as shown by FIG. 6. This may permit the entire label to be affixed to an implement or object with the indicia side observable. The nature of the adhesive can be modified to suit the circumstances required, including the nature of the surface of the object to which it shall be affixed and the level of permanence desired in affixing the label. For many types of label substrates, adhesive may be unnecessary, as in the case of a metal foil which may simply conformed to the exterior of the object.

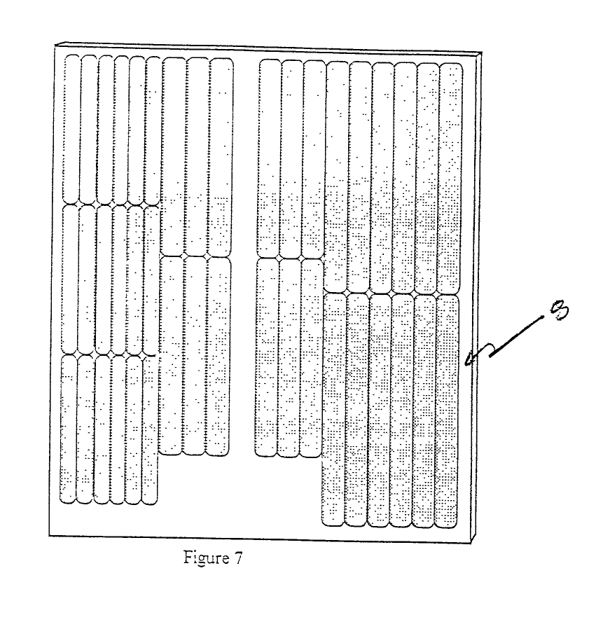

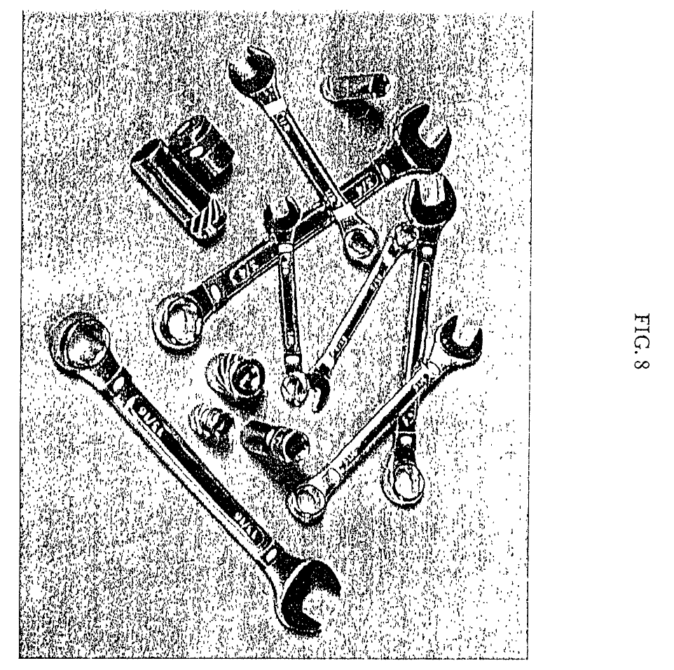

FIG. 7 shows an approximation of how a collection of the label embodiment of the invention having multi-tiered indicia might be produced and offered to the consumer. The individual substrates (3) are shown in a variety of lengths and widths suitable to the size of the objects to which they would be affixed. Multiples of each indica substrate would be included to allow use on duplicate-sized objects or implements.

The individual substrates are collected on a backing sheet (8) from which they are easily peeled off and subsequently attached to the intended implement. This embodiment of the invention may allow universality in application to various objects, implements or tools. This invention may be used upon virtually all makes and models of tools, especially socket and hand wrenches, regardless of age or manufacturer of the original set.

With respect to use of the label embodiment of the invention, the labels are simply peeled from the backing sheet and affixed to the appropriate objects, implements or tools. Each implement of a particular size or style would have affixed thereto a strip of substrate material having the desired number of tiers of indicia. For example, each collection of objects, implements or tools would receive a substrate material having the same first tier indicia. Each individual member of the set having a unique characteristic, such as size, would receive a different second tier indicia.

As shown in FIG. 8, the user of the present invention would simply select the correct indicia-coded material for each object, implement or tool, and affix it to thereto. In one method of use, the user would ascertain that all implements of the same style or size would bear the same first tier indicia, such as color, on a label. The label may be affixed to the implement in a similar location and in a manner that provides consistency and ready identification.

Also embodied in the present invention may be the simple production nature and the resulting inexpensive, cost efficient value for the end user. The indicia labeling pieces are designed to be durable, even under frequent use in the rigors of industrial, manufacturing or maintenance shop conditions. The invention's extremely low cost and ease of affixing makes any repair of the indicia material unnecessary, as the components of this system are designed to be disposable and replaceable.

As may be easily understood from the foregoing specification, the basic concepts of the present invention may be embodied in a variety of ways. They involve both methods of using multi-tiered indicia and various embodiments of multi-tiered indicia. In this application, a multi-tiered indicia labeling system is disclosed as part of the results shown to be achieved by the various multi-tiered indicia devices described and as steps which are inherent to utilization. They are simply the natural result of utilizing the devices as intended and described. In addition, while some devices are disclosed, it should be understood that these not only accomplish certain methods, but also can be varied in a number of ways. Importantly, as to all of the foregoing, all of these facets should be understood to be encompassed by this disclosure.

I claim:

1. A multi-tiered indicia system for individually identifying a multiplicity of articles, each article having a plurality of indicia characteristics applied thereto, each indicia characteristic being indicative of a different common level of association between certain ones of the multiplicity of articles.

2. A multi-tiered indicia system as in claim 1, wherein the articles comprise tools.

3. A multi-tiered indicia labeling system for identifying articles, the system comprising a label adapted for association with each article the label having a first tier indicia thereon indicative of a particular article within a particular collection of articles, the label having a second tier indicia thereon common to and indicative of all articles forming a particular collection of articles within multiple collections of articles, and the label having a third tier indicia thereon common to and indicative of the multiple collections of articles.

4. A multi-tiered indicia labeling system as in claim 3, wherein the articles comprise tools.

5. A multi-tiered indicia labeling system as in claim 3, wherein each label has an adhesive backing for affixing the label to each article.

6. A multi-tiered indicia system as in claim 1, wherein at least one of said plurality of indicia characteristics is non-visible.

7. A multi-tiered indicia system as in claim 1, wherein one of said plurality of indicia characteristics comprises color.

8. A multi-tiered indicia system as in claim 1, wherein one of said plurality of indicia characteristics comprises a tactile surface.

9. A multi-tiered indicia system as in claim 1, wherein one of said plurality of indicia characteristics comprises odor.

10. A multi-tiered indicia system as in claim 1, wherein at least one of said plurality of indicia characteristics comprises alphanumeric information.

11. A multi-tiered indicia labeling system as in claim 3, wherein each label has blunt and rounded ends.

12. A multi-tiered indicia labeling system as in claim 3, wherein each label comprises a conformable material.

13. A kit containing a plurality of multi-tiered indicia labels for use in identifying a multiplicity of articles, each label adapted for being affixed to one of said articles and each label having a plurality of indica characteristics each indicia characteristic being indicative of a different common level of association between certain ones of the multiplicity of articles.

14. A kit as in claim 13, wherein said plurality of multi-tiered indicia labels are provided on a backing sheet, to which they are removably adhesively attached.

15. A kit as in claim 13, wherein said plurality of multi-tiered indicia labels are provided in a variety of sizes suitable to the size of the articles to which they are affixed.

16. A method for identifying a multiplicity of articles, each article having a plurality of indicia characteristics, each indicia characteristic being indicative of a different common level of association between certain ones of the multiplicity of articles, each indicia characteristic being indicative of a different common level of association between certain ones of the multiplicity of articles, the method comprising the steps of:
determining the number of different common levels of association;
determining the indicia characteristic to be indicative of each of the different common levels of association; and
applying the plurality of indicia characteristics determined to be indicative of each of the different common levels of association to each of the multiplicity of articles.

17. A method as in claim 16, wherein the articles comprise tools.

18. A method as in claim 16, wherein the indicia characteristics are contained on labels.

19. A method as in claim 16, wherein at least one of said plurality of indicia characteristics comprises alphanumeric information.

20. A method as in claim 16, wherein at least one of said plurality of indicia characteristics comprises a tactile surface of said articles.
